(19) United States
(12) Patent Application Publication
(10) Pub. No.: US 2012/0324739 A1
(43) Pub. Date: Dec. 27, 2012

(54) Powered Drywall Tape Cutter

(76) Inventors: Douglass Wambaugh, Bend, OR (US); Timothy Smythe, Bend, OR (US)

(21) Appl. No.: 13/476,481

(22) Filed: May 21, 2012

Related U.S. Application Data
(63) Continuation-in-part of application No. 12/380,672, filed on Mar. 2, 2009.
Application No. 12/380,672 is a continuation-in-part of application No. 11/258,820, filed on Oct. 26, 2005, now abandoned.

(51) Int. Cl. B26B 27/00; B26D 1/12

(52) U.S. Cl. 30/266; 83/586; 83/438

(57) ABSTRACT

A power cutter tool for applying drywall tape or plastic drywall trim product that contains a powered blade that can cut the tape or trim material by simply pressing a trigger. The cutter can be powered by a spring or springs, a motor, hydraulically or by any other means. The trigger can be a button, lever, valve or any other means for releasing a powered blade.

This is a continuation-in-part of application Ser. No. 12/380,672 filed Mar. 2, 2009 which was is a continuation-in-part of application Ser. No. 11/258,820 filed Oct. 26, 2005. Application Ser. Nos. 12/380,672 and 11/258,820 are hereby incorporated by reference.

### BACKGROUND

1. Field of the Invention

The present invention relates generally to the field of drywall installation and more particularly to a cutter for plastic drywall trim product.

2. Description of the Prior Art

There are many pieces of equipment used in the drywall taping industry to help the installer apply drywall tape of various types (paper, mesh, plastic, laminates, etc) to the joints or corners between two pieces of drywall board. Many of these devices incorporate a cutter to cut the tape at the end of each joint or corner. All of these cutters on these various pieces of equipment are powered by hand, arm or finger motion at the time of each cut. That is the force of the hand, arm or finger actually powers the cutting mechanism. This can be strenuous and awkward given the repetitive nature of the work and that the installer may be in an awkward position, reaching, stretching, bending or otherwise in a bad position to perform the require motion to actuate the cutter. In addition, newer products like paper-plastic-paper laminates called plastic drywall trim are being used more and more. These products are generally too stiff and hard to cut by hand without sawing them.

What is needed is to power the cutter for any of these devices so all the installer has to do is pull a trigger, push a button, or otherwise release some other source of power, just like the trigger on a gun, to perform a cut, in particular to cut plastic drywall trim pieces.

### SUMMARY OF THE INVENTION

The present invention relates to a powered cutter for dispensing and cutting drywall tape or plastic drywall trim. The cutter can contain a trigger, sliding tube, rotating handle, or squeeze handle. Squeezing the trigger triggers the cutter to cut a piece of drywall tape or trim. The cutter can be powered by springs, a motor, hydraulics, or by any other means. The preferred embodiment is a spring-powered cutter where the spring is cocked with a lever and released with a trigger. The spring causes a mass to rotate that carries enough angular momentum to cause the driven blade to cut through plastic drywall trim.

### DESCRIPTION OF THE FIGURES

FIG. 1 shows a cutter in cocked or ready position.

FIG. 2 shows a cutter hitting the bottom of a cutting blade.

FIG. 3 shows a cutter moving the cutting blade up and over a stationary blade.

Several drawings and illustrations have been presented to better aid in the understanding of the present invention. The scope of the present invention is not limited to the figures.

### DESCRIPTION OF THE INVENTION

The present invention relates to a powered cutter for cutting drywall plastic trim pieces as well as drywall tape. This cutter can contain a trigger which can be any form such as a thumb operated lever, sliding tube, rotating handle, or squeeze handle or any other form of mechanism to activate, or release the power to drive the cut. Squeezing the trigger does not take much force or length of motion and instantaneously triggers the cutter to use it's stored power to perform a cut automatically. The cutting action is normally initiated by human action but is powered (or carried out) by something other than human strength. The cutting action can be powered by any kind of spring (torsion, compression, tension, etc), by electric power (linear actuator, motor, etc), by hydraulic or pneumatic power (cylinders, bellows, etc.) or any other types of power sources. This power can be used to drive a blade through drywall trim material of thickness greater than ⅛ inch. In general, a rotating mass, when driven by a spring, acquires enough angular momentum to force a blade through a piece of ⅛ inch or thicker plastic drywall trim product or drywall tape cutting it. The precise angular momentum needed is depends on the thickness of the material and the width of the piece being cut. Widths typically range from 1-6 inches for plastic drywall trim material.

While, the powered cutter of the present invention can be used on any type of drywall tapping equipment, tape dispensers, etc) and with any kind of tape material (paper, mesh, plastic, laminates, etc), it is preferred to use it with plastic drywall trim material.

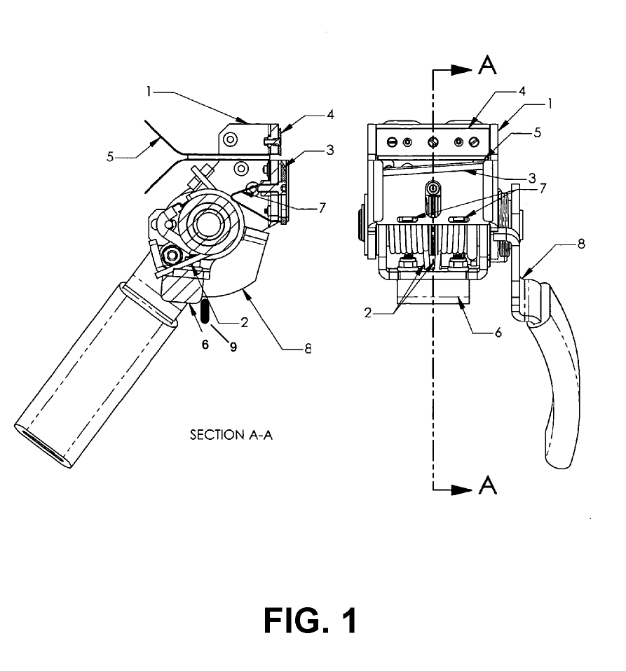

FIGS. 1, 2 and 3 show a front and section view of the powered cutter of the present invention. The powered cutter shown in the particular embodiment of the figures utilizes torsion springs for power to perform the cut. The mechanism includes a frame 1, torsion springs 2, slanted moving cutting blade 3, stationary butting blade 4, taping product guide 5, a mass and rotor 6, a return spring 7, a cocking handle 8 and a latch/release mechanism 9.

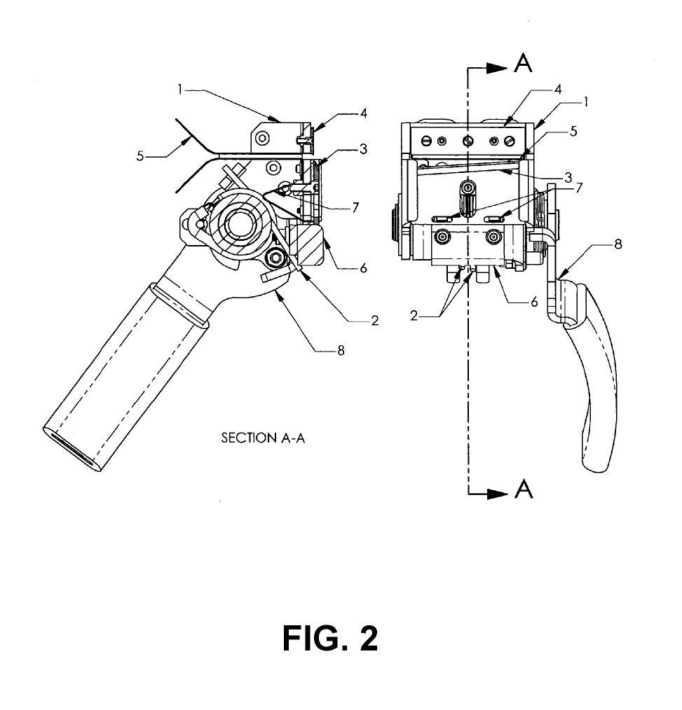

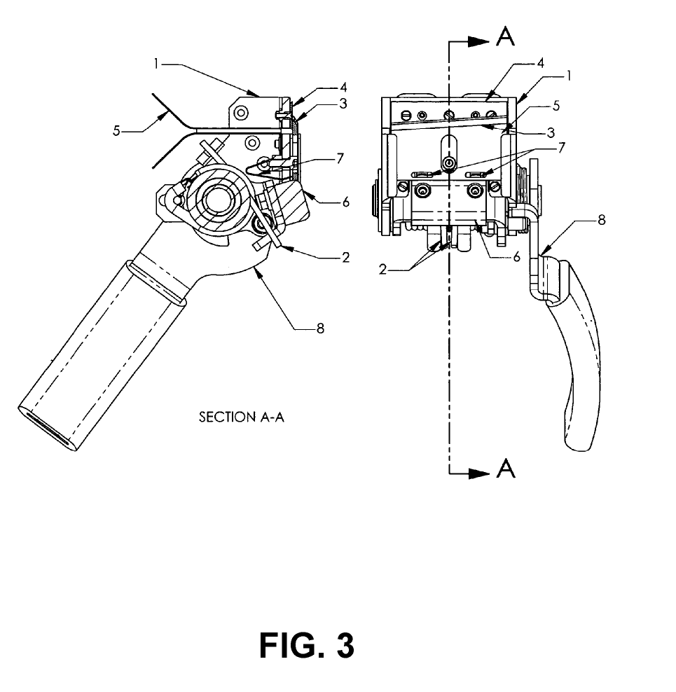

FIG. 1 shows an embodiment of a cutter in a cocked, or ready position held cocked by the latch/release mechanism 9. FIG. 2 shows the cutter hitting the bottom of the moving cutting blade 3 driving the moving cutting blade up and over the stationary cutting blade 4 as shown in FIG. 3.

When the handle 8 is pulled back, it brings with it the mass and rotor which rotate about a shaft held in the frame 1. When the mass and rotor are pulled back far enough by the handle, the mass and hammer catch and are held on a retaining and release mechanism, or latch 9, connected to the activation trigger by a cable or other means. The handle is then released and the cutter is cocked and ready to perform a cut as shown in FIG. 1.

The installer applies the tape or plastic trim in the normal way. The trim or taping material can be fed through the cutter by means of a guide 5. The guide 5 does not hinder the product moving through it, but guides the product between the moving cutting blade 3 and the stationary cutting blade 4 so that it may be cut when the mechanism is triggered by the operator. Tape or trim can be fed from a roll or straight in.

At the end of the corner or joint, the cutter is easily activated by a trigger mechanism which releases the stored power of the power source, a torsion spring 2 in the embodiment shown. The mass and rotor 6 are driven rotationally around the shaft by the torsion springs 2 until they impact the bottom of the moving cutting blade 3 as shown in FIG. 2 with enough momentum to cause the slanted blade to cut through at least ⅛ inch paper-plastic-paper drywall trim material.

At the time of impact between the mass and rotor 6 and the moving cutting blade 3 the torsion springs 2 have normally stopped applying force to the mass and rotor 6, and the mass and rotor 6 are coasting with tremendous momentum as the mass impacts the bottom of the moving cutting blade 3. The mass and rotor 6 impart their energy to the moving cutting blade 3 making it move past the stationary cutting blade 4 cutting the product which has been guided between the blades by the guide 5. This action happens very quickly once the mechanism has been triggered.

A return spring 7 applies a light constant force to the moving cutting blade 3 to keep it “open” (or from being over the stationary cutting blade 4) and allows product to move through the guide 5 and be applied to the joint or corner. The cutting blades are normally open and ready (cocked) during equipment operation. Once the mechanism is triggered, the cutter performs a cut without power from the operator.

While prior art cutters in drywall taping equipment require human power to perform the cut at the time of each cut, the powered cutter of the present invention only needs to be released by some light trigger mechanism, (lever, button, valve, etc.), and finds significant application in cutting plastic drywall trim pieces.

Several descriptions and illustrations have been presented to better aid in understanding the present invention. One with skill in the art will recognize that many changes and variations are possible. Each of these changes and variations is within the scope of the present invention.

We claim:

1. A drywall trim cutter used to cut plastic drywall trim comprising, in combination,
a frame containing at least a torsion spring, a rotating mass and rotor, a moving cutting blade, a stationary butting blade, and a cocking handle;
wherein, said torsion spring is coupled to said moving blade, said torsion spring being tensioned by said cocking handle to a cocked position, said torsion spring releasable from said cocked position causing said rotating mass to acquire sufficient momentum to cause said cutting blade to close on said stationary butting blade cutting a section of plastic drywall trim up to ⅛ inch thick between said cutting blade and said stationary butting blade; and
whereby said drywall trim cutter dispenses and cuts plastic drywall trim strips into cut pieces.

2. The drywall trim cutter of claim 1 further comprising a product guide that guides said drywall trim between said moving blade and said butting blade.

3. A device for dispensing and cutting plastic drywall trim products comprising:
a frame adapted to be mounted on an elongated handle;
a trim guide attached to said frame;
a driving spring and rotating mass contained by said frame;
a slanted, movable cutting blade that moves between a feed position and a cut position and stationary butting blade that can be engaged by said movable cutting blade, said movable cutting blade and said stationary butting blade contained by said frame;
a cocking handle;
a retaining latch adapted to release said rotating mass from a cocked position;
wherein, said driving spring can be cocked by said cocking handle and retained by said retaining latch, said driving spring mechanically coupled to said rotating mass; and
wherein, when said rotating mass is released, said driving spring causes said rotating mass to acquire sufficient angular momentum to cause said movable cutting blade to cut a piece of plastic drywall trim material at least ⅛ thick between said movable cutting blade and said stationary butting blade; and
wherein after cutting, a return spring causes said movable cutting blade to return from said cut position to said feed position allowing plastic drywall trim to be fed through said trim guide, said trim guide being positioned so that said plastic drywall trim feeds between said movable cutting blade and said stationary butting blade.
